(19) United States
(12) Patent Application Publication
(10) Pub. No.: US 2006/0242651 A1
(43) Pub. Date: Oct. 26, 2006

(54) Activity-based PC adaptability

(75) Inventors: Tobiasz A. Zielinski, Redmond, WA (US); Kamesh Chander Tumsi Dayakar, Redmond, WA (US); Ravipal S. Soin, Sammamish, WA (US); Vikram Madan, Bellevue, WA (US); William Mak, Seattle, WA (US); Ryan Edward Cukierman, Redmond, WA (US)

Correspondence Address: LAW OFFICES OF ALBERT S. MICHALIK;C/O MICROSOFT CORPORATION, 704 - 228TH AVENUE NE, SUITE 193, SAMMAMISH, WA, 98074, US

(73) Assignee: Microsoft Corporation, Redmond, WA (US)

(21) Appl. No.: 11/112,464

(22) Filed: Apr. 21, 2005

(51) Int. Cl. G06F 9/46

(52) U.S. Cl. 719/318

(57) ABSTRACT

A method and system for adapting system behavior based on activities. An activities engine determines or is informed of the current activity and instructs a notification component to notify registered programs (also known as notification consumers) about the current activity. Upon receipt of the notification, the notification consumers modify their behavior if appropriate. When an activity ceases, the activities engine may instruct the notification component to notify the registered programs so that they may resume their normal behavior.

### FIELD OF THE INVENTION

The present invention relates generally to computing devices, and more particularly adapting computing devices to activities associated therewith.

### BACKGROUND

Computers, especially mobile computers, may be used in various activities. For example, a computer may be used in a meeting, during a presentation, while traveling, for entertainment, and to do work in an office. A system behavior appropriate for one activity may not be appropriate for another activity. For example, conserving battery life at the expense of performance may not be appropriate when giving a presentation.

In the past, users have been able to change system behavior in preparation for performing a new activity via a multitude of configuration screens. Unfortunately, forgetting to change particular settings before performing certain activities may cause embarrassment. For example, if a computer enters sleep mode or turns off during a question and answer session of a presentation, there may be an embarrassing pause when the computer is restarted to resume the presentation.

What is needed is an improved method and system for adapting system behavior in response to or in preparation for changing activities. Ideally, such a method and system would be easy to use and extensible to new activities.

### SUMMARY

Briefly, the present invention provides a method and system for adapting system behavior based on activities. An activities engine determines or is informed of the current activity and instructs a notification component to notify registered programs (also known as notification consumers) about the current activity. Upon receipt of the notification, the notification consumers modify their behavior if appropriate. When an activity ceases, the activities engine may instruct the notification component to notify the registered programs so that they may resume their normal behavior.

Other aspects will become apparent from the following detailed description when taken in conjunction with the drawings, in which:

### BRIEF DESCRIPTION OF THE DRAWINGS

FIG. 1 is a block diagram representing a computer system into which the present invention may be incorporated;

FIG. 2 is a block diagram representing an exemplary environment in which the present invention may operate in accordance with various aspects of the invention;

FIG. 3 is a block diagram showing another representation of the activity engine 215 of FIG. 2 in accordance with various aspects of the invention;

FIG. 4 is a block diagram representing exemplary activity requestors interacting with an activity engine in accordance with various aspects of the invention;

FIG. 5 is a block diagram representing exemplary components that a notification API may notify when an activity mode is entered by a machine in accordance with various aspects of the invention;

FIG. 6 is a state diagram of exemplary states that may occur in accordance with various aspects of the invention. In the normal (or default) state 600 a default or previous activity profile is applied;

FIG. 7 is a flow diagram that generally represents exemplary actions that may occur when receiving an explicit request to change activity from an activity requestor in accordance with various aspects of the invention; and

FIG. 8 is a flow diagram that generally represents actions that may occur when monitoring for activities in accordance with various aspects of the invention.

### DETAILED DESCRIPTION

Throughout the specification and claims, the following terms take the meanings explicitly defined herein, unless the context clearly dictates otherwise:

The term “include” and its variants should be read as an open-ended list which includes, but is not limited to, the items following, unless the context clearly dictates otherwise.

Exemplary Operating Environment

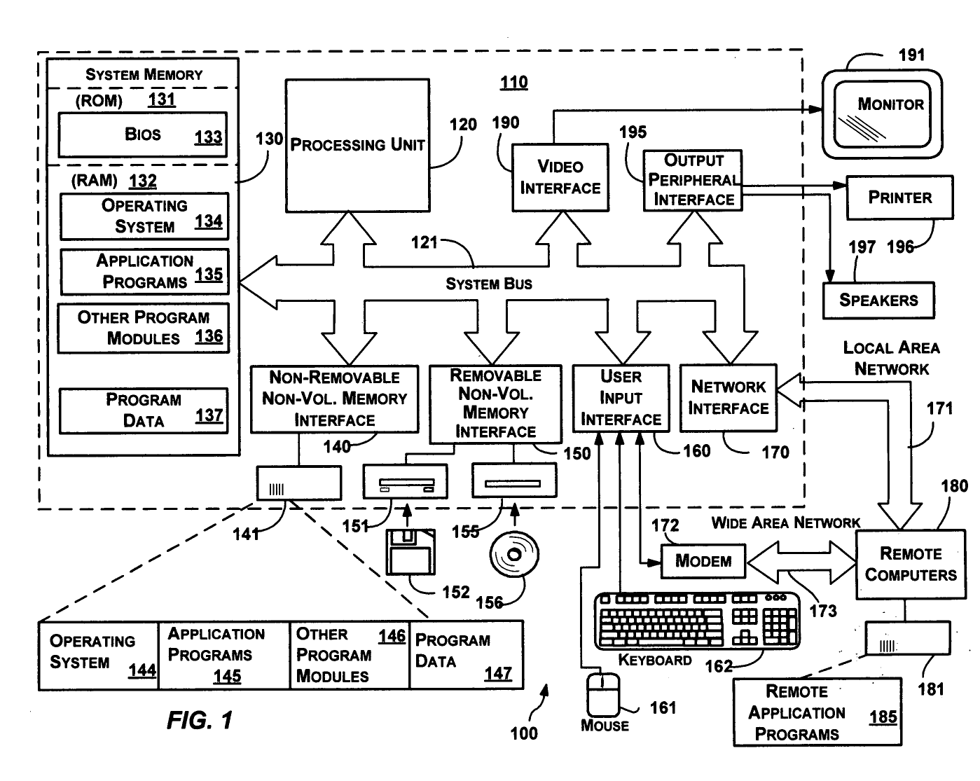

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include personal computers, server computers, hand-held or laptop devices, multiprocessor systems, microcontroller-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the invention includes a general-purpose computing device in the form of a computer 110. Components of the computer 110 may include a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer-readable media. Computer-readable media can be any available media that can be accessed by the computer 110 and includes both volatile and nonvolatile media, and removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data. Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 110. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media, discussed above and illustrated in FIG. 1, provide storage of computer-readable instructions, data structures, program modules, and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers herein to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, a touch-sensitive screen of a handheld PC or other writing tablet, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160 or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

Activities Adaptation

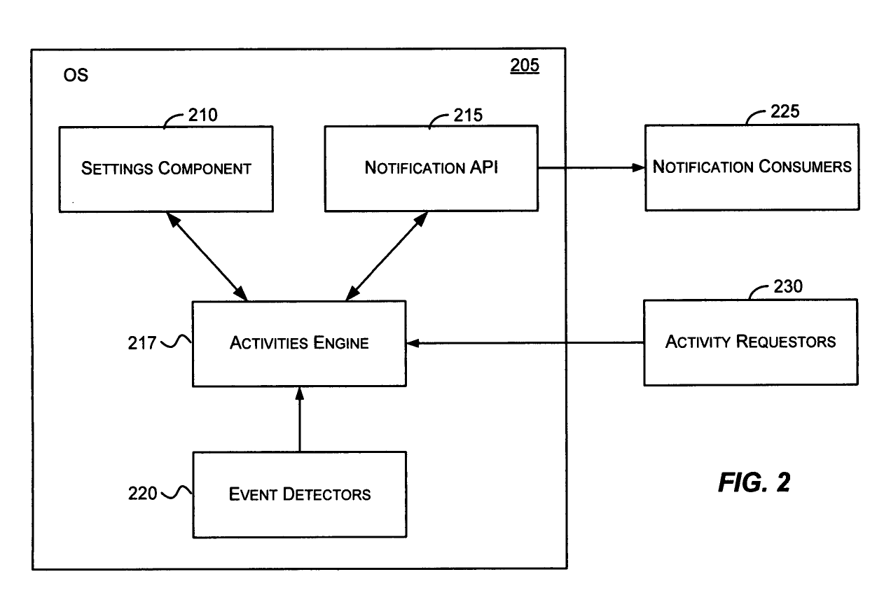

FIG. 2 is a block diagram representing an exemplary environment in which the present invention may operate in accordance with various aspects of the invention. The environment includes an operating system 205, notification consumers 225, and activity requesters 230. The operating system includes a settings component 210, a notification application programming interface (API) 215, an activities engine 217, and event detectors 220.

The activities engine 217 may set settings via the settings component 210, may launch applications or wizards, and may change shell behavior (e.g., OS user interface behavior) to adapt a machine to a particular activity. Each setting may be set to a value included in an activity profile associated with a particular activity. Settings may comprise battery consumption settings, display settings, notification settings, sound settings, mouse pointer settings, file synchronization settings, other settings, and the like.

Exemplary battery consumption settings include full or conservative CPU power consumption (if available), turning or not turning off a monitor after a specified amount of time, turning or not turning off hard drives after a specified amount of inactivity, going or not going into standby after a specified amount of inactivity, saving or not saving system state on disk and shutting down the system after a specified amount of activity (sometimes referred to as hibernation), and the like.

Exemplary display settings include allowing or not allowing a screen to be shut off, allowing or not allowing a screen saver to become active, specifying a screen saver to activate (if allowed to become active), specifying a timeout before a screen saver can become active (if allowed to become active), resolutions settings, refresh rate, color depth, extending a desktop display onto an external monitor, using or not using ClearType® to display text, setting the brightness of a monitor, and the like.

Exemplary notification settings include showing all notifications as usual, hiding all notifications, hiding all but critical notifications such as critical battery power, showing notification on a primary or designated display only (if two displays are available), showing or not showing mail notifications, showing or not showing instant communication notifications, showing or not showing system notifications, and the like.

Exemplary sound setting include the sound level for the master volume, playing all sounds, muting warnings and notifications, muting all sounds, muting sounds from some components but allowing other components to provide sounds, allowing sounds from a component with which the user is actively interacting, and the like.

Exemplary mouse pointer settings include user defined mouse pointers, standard system-shipped mouse pointers, and the like.

Exemplary other settings include setting a default Web browser home page, setting an instant communication component to indicate availability, indicating whether a password is required to resume from standby, indicating whether a password is required to resume from a screensaver, indicating a default mail client, specifying the most recently used list of a start menu, specifying sidebar titles, indicating whether scheduled tasks may begin, and the like.

Exemplary activities include presenting, attending a meeting, traveling, entertainment including game playing and multimedia, working at a desk, default activity, user-defined activities, and the like. Each activity may be best suited for particular settings.

In one embodiment, the activities engine 217 may control the behavior of OS-related components via the settings component 210 and may suggest appropriate behavior (e.g., no notifications and sounds) to non OS-related components (e.g., notification consumers 225) via the notification API 215 (also referred to as the notification component). The notification API 215 may send notification to each notification consumer 225 that has registered with it that a particular activity is occurring and may provide an indication (e.g., pointer to a data structure) that indicates appropriate behavior to the notification consumers 225.

In another embodiment, the activities engine 217 may suggest the behavior of both OS-related and non OS-related components via the notification API 215. In this embodiment, notification consumers 225 may include both OS and non-OS components.

In another embodiment, a notification consumer may query the activities engine 217 via the notification API 215 before it engages in a behavior (e.g., providing a sound or visual notification). In response to the query, the activities engine 217 may then indicate to the notification customer what activities the notification customer may engage in.

In another embodiment, the activities engine 217 may control the behavior of both OS-related and non OS-related components. Components that respond to the settings component 210 may be controlled through the appropriate settings while components that are not controlled via the settings component 210 may have their behavior (e.g., notification and sounds) controlled by the operating system 205.

Even though shown outside the OS 205 in one embodiment, in another embodiment, the activity requesters 230 may include OS and non-OS components that may explicitly request that the activities engine 217 adapt the machine to a particular activity. In response thereto, the activities engine 217 takes appropriate action.

The event detectors 220 provide notification of events to the activities engine 217. For example, an event detector may inform the activities engine 217 that a projector has been connected to the machine. This may cause the activities engine 217 to enter a presentation mode, for example.

Activity profiles may be stored and accessed by the activities engine 217. An activity profile may indicate settings that need to be set in the settings component 210 instructions to provide to the notification API 215, and/or applications to launch and settings to be applied thereto. For example, an entertainment activity profile may cause a media player to be launched with a selected play list and skin.

An activity profile may be system-defined (e.g., provided with an install of a system component) or user-defined (e.g., created or customized by a user). An activity profile may be associated with an activity, one or more devices, a state of the system (e.g., a set of currently executing applications or connected devices), a combination of the above, and the like.

When an activity profile is associated with an activity, the profile may be applied in response to an explicit request (e.g., via user or application selection) or through heuristics (e.g., via automatic detection of the activity). For example, a user or an application may specifically request that a presentation activity profile be applied. In response to the request, the activities engine 217 may apply a presentation activity profile and cause the machine to enter a presentation mode.

Certain buttons on a machine or peripherals attached thereto may be associated with a selected activity. For example, a button may be placed on a keyboard and associated with an entertainment activity profile. Whenever the button is pressed, the associated entertainment activity profile may be applied. Similarly, a button may be placed on a display and associated with a presentation activity profile.

Heuristics may use any method of detecting system state and selecting an activity profile based thereon. For example, plugging a projector into a computer may indicate that a presentation activity is about to begin. As another example, having a multimedia application running in full screen mode may indicate that an entertainment activity is occurring. Alternatively, if a multimedia application is running and consumes a significant portion of the computing power of the machine, this may indicate that an entertainment activity is occurring. As another example, if a user attempts to broadcast a presentation via a network, a heuristic may detect this as a presentation activity. In response the activity engine may find and apply an appropriate activity profile.

When an activity profile is associated with one or more devices, the activity profile may be applied when an event detector detects that the one or more devices are connected to the machine. For example, upon connection, a display may transmit an identifier that uniquely identifies the display (e.g., a projector in a particular room or a monitor at a user's desk). If an event detector indicates that the display has been connected to the machine, the activities engine may use the identifier to locate and apply an activity profile associated with the display.

When a device is connected to a machine, the user may be prompted create a new activity profile, modify an existing activity profile, or select an existing activity profile to associate with that device. The user may also indicate what class of device the device is (e.g., presentation display, desktop monitor, camera, video recorder, and the like). Each time the device is subsequently connected to the machine, the activity profile may be applied to the machine.

In addition to an identifier that uniquely identifies a device, some devices may also be able to provide an identifier that identifies the class of device (e.g., projector, TV, desktop monitor, auditorium speaker, and the like). Each class of devices may be associated with a particular activity profile. Upon detecting that a device of a particular type has been connected to the machine, the associated activity profile may be automatically applied.

In addition, a user interface may be available to allow a user to view all devices that have been connected to the machine at one time or another. Through this interface, the user may be able to change the class of device and profile associated with the device. The user interface may also allow the user to create, modify, delete, or associate activity profiles at any time the user desires (instead of in response to a device being connected to the machine).

When an activity profile is associated with a system state, the activity profile may be applied when the state is detected. For example, an entertainment activity profile may be applied when the system detects that a multimedia application is executing in full screen.

If more than one activity profile is associated with a particular activity, the most specific profile may be applied. For example, a presentation activity profile may be associated with a state of the system that includes executing a presentation application in a full screen mode. If the machine is also connected to a presentation monitor that is associated with a specific activity profile, however, the activity profile associated with the presentation monitor may supersede the presentation activity profile. Furthermore, an explicit indication of which activity profile should be applied (e.g., through user or application request) may override any other activity profiles that may be applied automatically.

During an activity such as a presentation, it may desirable to stop notifications from appearing, to stop system sounds from sounding, to set a sound volume level for the sounds provided by the sound application, to stop a screen saver from activating, to stop the screen from blanking, to prevent the system from powering down (e.g., to a standby, sleep, or off mode), to have the computer run at full CPU speed to reduce any latencies, to increase the display brightness, to change screen resolution, and to change the background wallpaper shown to no background wallpaper or to a selected background wallpaper (e.g., to a company logo or company standard type of wallpaper). A user may be able to indicate how long the activity may last so that the activity engine 215 may subsequently reset settings to normal afterwards (e.g., to avoid draining the battery).

During an activity such as an in-flight activity, among other things, it may be desirable to stop any activity that may interfere with the airplane's operation (e.g., to cease wireless and other RF transmissions).

An activity may be triggered by the detection of an event by the event detectors 220. For example, plugging in a projector may signal that a presentation activity is about to begin. In response, the activities engine 217 may set settings via the settings component 210 to put the computer into a presentation mode. In addition the activities engine 214 may notify the notification API 215 that a presentation activity is occurring and indicate that applications that have subscribed to the notification API 215 should be notified to not place any notifications on the screen during the presentation.

An activity may also be triggered by request from an application or other system component. For example, a system component may request that a network presentation activity profile be applied when a network presentation occurs. As another example, a mail client may determine that a meeting is occurring and may request that a meeting activity profile be applied. The mail client may use a heuristic of how many people are invited to the meeting to determine whether to request that a meeting activity profile be applied or a presentation activity profile be applied. In general, any application or system component may indicate that a particular activity is occurring and request that an appropriate activity profile be applied.

In one embodiment, an activity profile associated with a presentation activity may include setting the screen so that it may not be blanked (e.g., due to inactivity) during the presentation, disabling the screen saver, disabling standby and hibernate, suppressing OS-related notifications, and suppressing non OS-related notifications and sounds or instructing the notification API 215 to notify the notification consumers 225 to stop sending screen and sound notifications.

Other heuristics may also be used to determine the activity that is occurring and adapt the machine appropriately without departing from the spirit or scope of the present invention.

An application or user that requests that an activity profile be applied may also specify how long the activity profile be applied. For example, a user may determine that a presentation will not last longer than one hour. In selecting a presentation activity profile, the user may be provided with a user interface that allows the user to indicate how long the presentation activity profile may be applied before reverting to a default or previous mode. After the time expires, a default or previous activity profile may be applied to the machine.

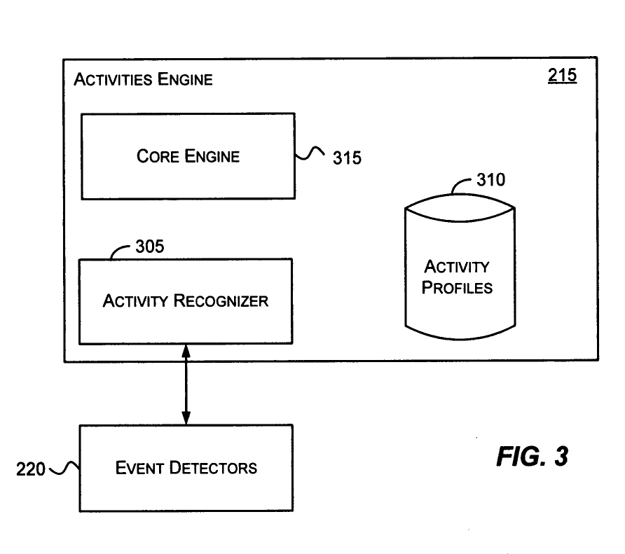

FIG. 3 is a block diagram showing another representation of the activity engine 215 of FIG. 2 in accordance with various aspects of the invention. In one embodiment, the activities engine 217 may include an activity recognizer 305, an activity profiles database 310, a core engine 315, and other components (not shown).

The activity recognizer 305 includes logic for detecting activities. It may obtain data from the event detectors 220 and may reference the activity profiles database 310 to correlate detected events with particular activity profiles. When the activity recognizer 305 detects an activity and its associated profile, the activity recognizer 305 may inform the core engine 315 which may then apply the profile.

The activity profiles database 310 may also store data associated with devices. For example, the data may include a device identifier together with what class of device the device is (e.g., presentation monitor, desktop monitor, camera, video recorder, and the like). As another example, the data may include the device indicator and associate the device indicator with a specific activity profile.

The core engine may include the logic to apply activity profiles to the machine.

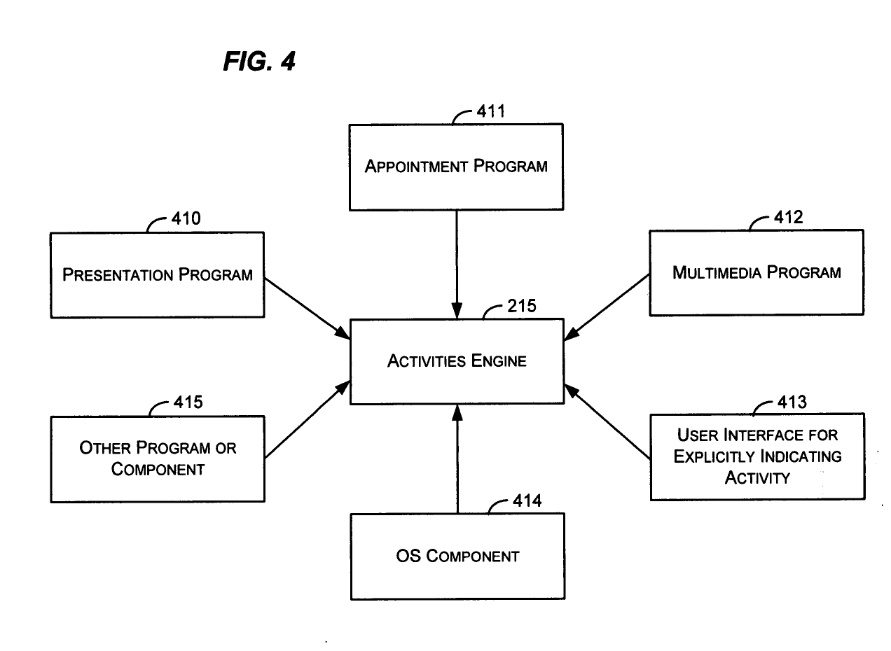

FIG. 4 is a block diagram representing exemplary activity requesters interacting with an activity engine in accordance with various aspects of the invention. Activity requestors may include a presentation program 410, an appointment program 411, a multimedia program 412, a user interface 413, an OS component 414, any other program or component 415, and the like.

In general, an activity requestor tells the activities engine 217 that a particular activity is about to occur, is occurring, or is over. In response, the activities engine 217 may apply a profile associated with the activity or apply a default or previous activity profile.

In one embodiment, the activity requester may also specify a particular activity profile to apply to the machine. If an activity profile is specified, the activities engine applies the specified activity profile to the machine.

An activity indicator may indicate a period during which the activity profile is to be applied. The start of the period may be immediate or at a future time. When the period begins, the activities engine 217 may apply an activity profile. After the period is over, the activity engine 215 may apply a default or previous activity profile.

More, fewer, or other activity requestor may be present without departing from the spirit or scope of the present invention.

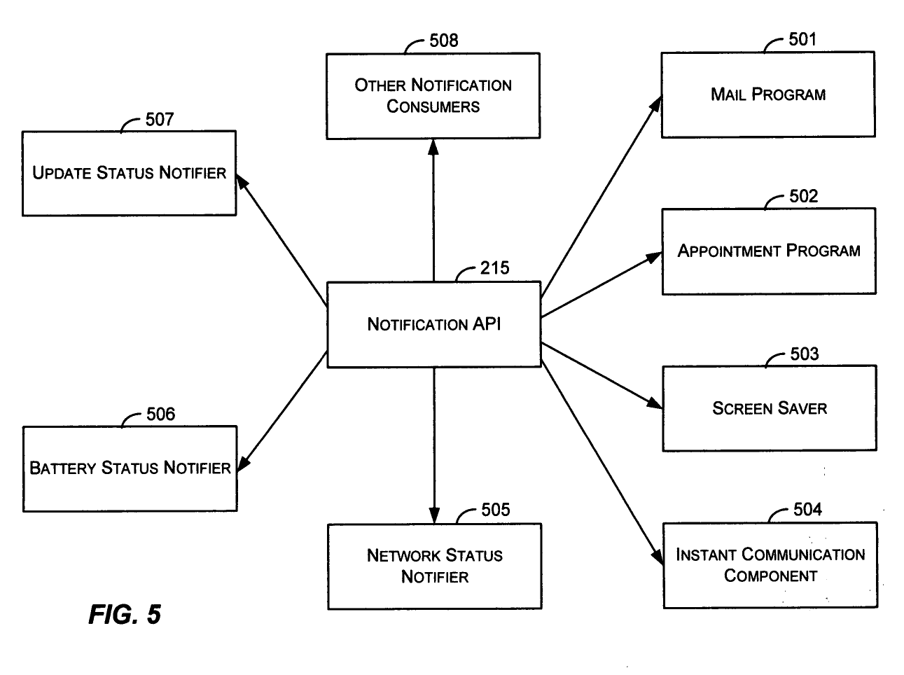

FIG. 5 is a block diagram representing exemplary components that a notification API may notify when an activity mode is entered by a machine in accordance with various aspects of the invention. Consumers of notifications sent by the notification API may include programs that have registered with the notification API 215 and OS components.

Some exemplary notification consumers include the mail program 501, the appointment program 502, the screen saver 503, the instant communication component 504, the network status notifier 505, the battery status notifier 506, the update status notifier 507, and the other notification consumers 508. These notification consumers may voluntarily suppress notifications in response to a message from the notification API 215, or the operating system may suppress any notifications they may attempt as previously described.

The network status notifier 505, battery status notifier 506, update status notifier 507, and other notification consumers 508 may comprise operating system components that send notifications in response to changes in system state. For example, the network status notifier 505 may indicate when network status changes, the battery status notifier 506 may indicate when battery charge becomes critical, and the update status notifier 507 may indicate when an operating system patch is available.

In one embodiment, the activity engine sets settings in the OS or elsewhere that cause these notifiers to cease notification.

It will be recognized that more, fewer, or other notification consumers may be included without departing from the spirit or scope of the present invention.

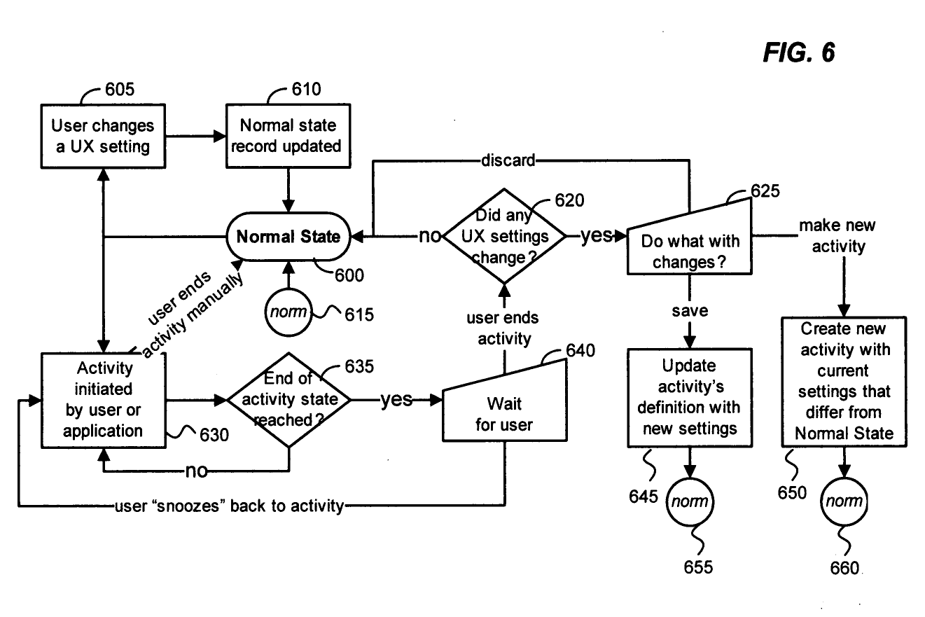

FIG. 6 is a state diagram of exemplary states that may occur in accordance with various aspects of the invention. In the normal (or default) state 600 a default or previous activity profile is applied. A user may change the normal settings (at state 605) after which the profile associated with the normal state is updated (at state 610). A user or program may indicate that an activity is occurring or is about to occur (at state 630). When the end of the activity is reached (at state 640), a prompt (at state 640) may be shown to a user, if the user initiated the activity.

When the user ends the activity in response to this prompt, the user may change the activity profile associated with the activity. If the user does not change this profile, the normal state 600 is reached. If the user does change this profile, a determination (at state 625) is made as to what to do with the changes. The user may update an old activity profile (at block 645) or create a new activity profile (at block 650). Afterwards, the normal state 600 is reached.

It should also be noted that the normal state 600 may be reached after an activity has been initiated (e.g., at block 630) if the user manually indicates that the activity is over.

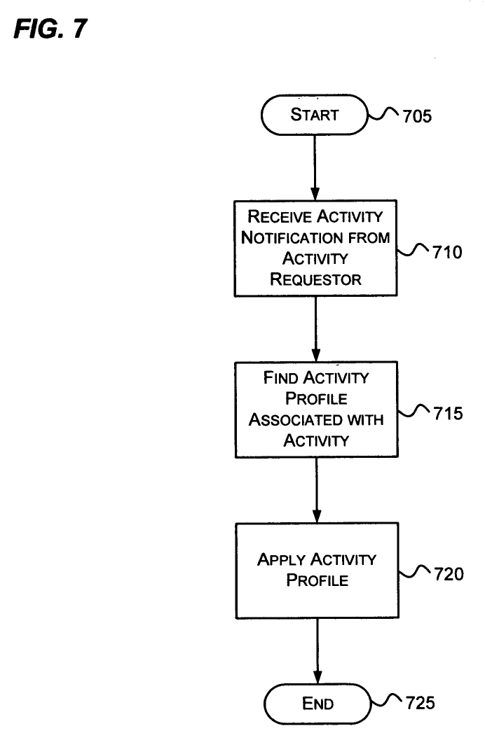

FIG. 7 is a flow diagram that generally represents exemplary actions that may occur when receiving an explicit request to change activity from an activity requestor in accordance with various aspects of the invention. At block 705, the actions start.

At block 710, an activity notification is received from an activity requester. In essence the activity requestor requests that the activity engine adapt the behavior of the system to a requested activity.

At block 715, an activity profile associated with the activity is found in the activity profiles database.

At block 720, the activity profile is applied to the system to change the behavior of components executing in the system.

At block 725, the actions end. The actions above may be repeated each time an activity requester notifies the activity engine of an activity.

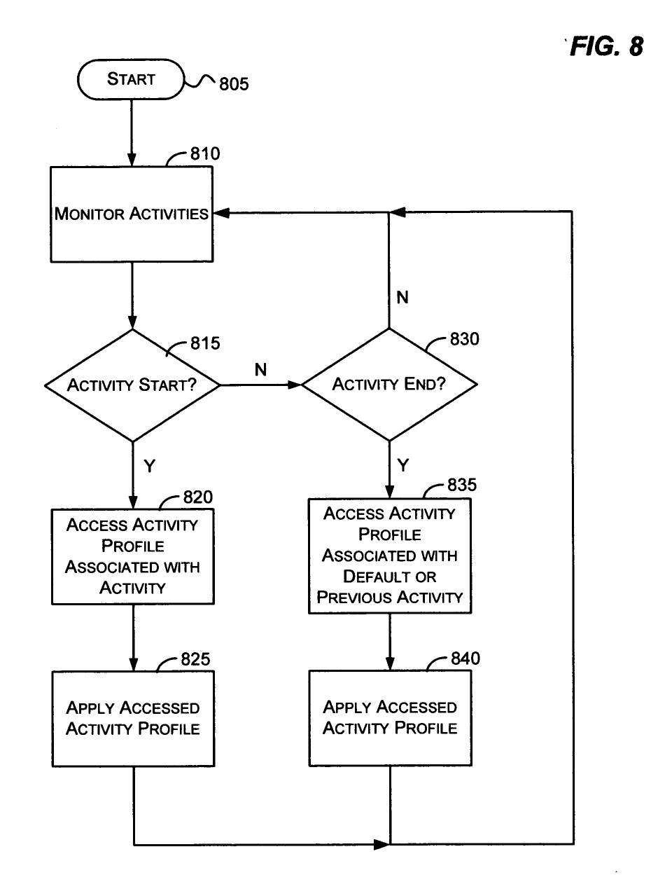

FIG. 8 is a flow diagram that generally represents actions that may occur when monitoring for activities in accordance with various aspects of the invention. At block 805, the actions begin.

At block 810, activities are monitored. For example, an activities engine may monitor events from event detectors to determine what activities are occurring on a machine.

At block 815, a determination is made as to whether an activity has started. If so, processing branches to block 820; otherwise, processing branches to block 830. For example, if an event detector detects that a hardware device has been connected and the hardware device is associated with an activity profile, the activities engine may determine that an activity has started.

At block 820, the activity profile associated with the activity is accessed and at block 825, the activity profile is applied.

At block 830, a determination is made as to whether an activity has ended. If so, processing branches to block 835; otherwise, processing branches to block 810. An activity may have ended, for example, if the indicated period during which the activity was to take place is over.

At block 835, a default or previous activity profile is accessed. The activity profile of an activity that occurred just before the current activity started may be stored in the activities profile database. In addition, a default activity profile may also be stored in the database.

At block 840, the accessed activity profile is applied. The actions may continue until the system or the activities engine is shut down.

As can be seen from the foregoing detailed description, there is provided a method and system for adapting system behaviors based on activities. While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. In a computing environment, a system comprising:
a notification component arranged to notify registered programs about activities;
a notification consumer arranged to register with the notification component to receive notification about the activities and to modify its behavior in response to a notification of a current activity; and
an activities engine arranged to determine the current activity and to instruct the notification component to notify the registered programs about the current activity.

2. The system of claim 1, further comprising:
an event detector arranged to detect when hardware is connected and disconnected from the system and to notify the activities engine in response thereto;
an activity requester arranged to request that the activities engine adapt the behavior of the system to a requested activity; and
a settings component arranged to receive instructions from the activities engine regarding the current activity and to set operating system settings in response thereto, wherein the settings cause the operating system to modify its behavior.

3. The system of claim 2, wherein the event detector is further arranged to obtain a unique identifier from the hardware that identifies the hardware and to provide the activities engine with the unique identifier.

4. The system of claim 3, wherein the activities engine is further arranged to select an activity profile based on the unique identifier, wherein the activity profile indicates settings for the settings component to set, instructions to provide to the notification component, and programs to launch.

5. The system of claim 2, wherein the event detector is further arranged to obtain an identifier that identifies a class of devices including the hardware device and to provide the identifier to the activities engine.

6. The system of claim 5, wherein the activities engine is further arranged to select an activity profile based on the identifier and to apply the activity profile to adapt the system to the requested activity.

7. The system of claim 2, wherein the activity requester comprises a program arranged to execute on the system and to request the requested activity before or when the program performs actions associated with the requested activity.

8. The system of claim 1, wherein the activities engine is further arranged to suppress screen and sound notifications from programs not registered with the notification component.

9. The system of claim 1, wherein an activity comprises one or more of presenting, attending a meeting, entertainment, an in-flight activity, a traveling activity, a default activity, and a user-defined activity.

10. The system of claim 1, wherein the activities engine is further arranged to access and apply activity profiles in adapting the system to the requested activity, and wherein an activity profile is associated with a particular activity, one or more hardware devices, a state of the system, or a combination thereof.

11. The system of claim 1, wherein the activities engine comprises an activity recognizer arranged to detect when the current activity is occurring via heuristics.

12. A computer-readable medium having computer-executable instructions, comprising:
receiving an activity notification from an activity requestor;
accessing an activity profile associated with the activity notification; and
applying the activity profile to change behavior of components executing on a computer.

13. The computer-readable medium of claim 12, wherein the activity requestor comprises a program that receives an explicit command from a user and provides the activity notification to an activity engine based thereon.

14. The computer-readable medium of claim 12, wherein the activity requester comprises a program that determines that the activity notification be sent when the program enters a presentation mode, and wherein the activity notification comprises information that identifies that the program is in the presentation mode.

15. In a computing environment, a method, comprising:
determining that an activity is occurring;
accessing an activity profile associated with the activity; and
applying the activity profile to change a behavior of components executing in a computer.

16. The method of claim 15, wherein determining that an activity is occurring comprises receiving an event notification that indicates that hardware has been attached to a computer, wherein the event notification includes a unique identifier that identifies the hardware, and wherein the activity profile is also associated with the hardware via the identifier.

17. The method of claim 15, wherein applying the activity profile to change the behavior of components executing in a computer comprises suppressing sound and display notifications attempted by the components.

18. The method of claim 15, wherein applying the activity profile to change the behavior of components executing in a computer comprises notifying the components and relying on the components to suppress their notifications.

19. The method of claim 15, further comprising:
determining that the activity has ceased; and
applying an activity profile associated with another activity occurring just prior to the activity.

20. The method of claim 15, further comprising:
receiving explicit instruction that the activity has ceased; and
applying a default activity profile to change the behavior of components executing in a computer.
